(19) United States
(12) Patent Application Publication
(10) Pub. No.: US 2019/0060161 A1
(43) Pub. Date: Feb. 28, 2019

(54) SEXUAL STIMULATION APPARATUS

(71) Applicant: Juan Moreno, Channel View, TX (US)

(72) Inventor: Juan Moreno, Channel View, TX (US)

(21) Appl. No.: 16/119,806

(22) Filed: Aug. 31, 2018

Related U.S. Application Data
(60) Provisional application No. 62/552,510, filed on Aug. 31, 2017.

(51) Int. Cl. A61H 19/00

(52) U.S. Cl. CPC A61H 19/44; A61H 19/50; A61H 2201/0192; A61H 2201/0161; A61H 2201/013

(57) ABSTRACT

A sexual stimulation apparatus includes a stand, having a first portion; a second portion pivotally attached to the first portion by a hinge; and a base pivotally attached to the second portion; the stand unfolds into an A-frame with the first potion being a first leg and the second portion being a second leg; a first dildo having a first attachment device to removably secure the first dildo to the first portion; and the stand folds substantially flat for storage.

### BACKGROUND

### 1. Field of the Invention

The present invention relates generally to sextual stimulation devices, and more specifically, to a sexual stimulation apparatus having various angles and the ability to fold flat for storage.

### 2. Description of Related Art

Sexual stimulation devices are well known in the art. Most stimulation devices are handheld, and therefore can be restrictive based on hand and arm movement of the user. In addition, a user's arm can fatigue, thereby further causing discomfort during use of the device.

Accordingly, although great strides have been made in the area of sexual stimulation devices, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a common sexual stimulation apparatus in accordance with a preferred embodiment of the present application;

FIG. 2 is a front view of a first portion of the apparatus of FIG. 1;

FIGS. 3A and 3B are side views depicting the attachment mechanism of FIG. 1;

FIG. 4 is a front view of an alternative embodiment of the first portion of the apparatus of FIG. 1;

FIGS. 5A and 5B are side views depicting an alternative attachment mechanism;

FIGS. 6A and 6B are side views of the apparatus of FIG. 1; and

FIGS. 7A, 7B, and 7C are side close up views of the hinge of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional sexual stimulation devices. Specifically, the present invention is not handled and therefore provides for easier use. In addition, the present invention is configured to provide multiple angles of use. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

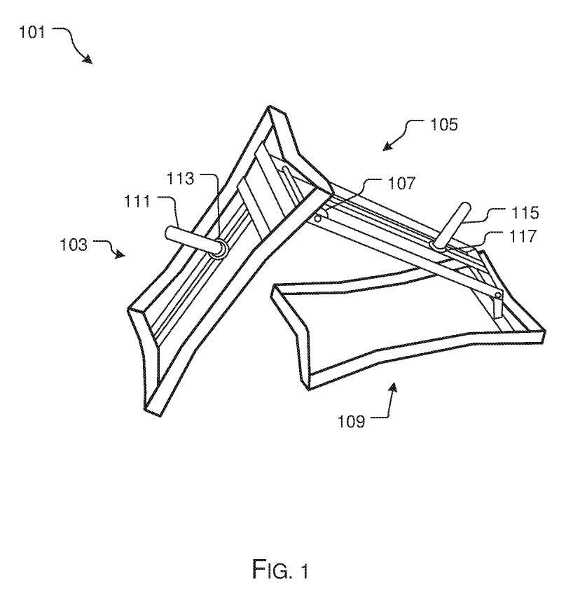

Referring now to the drawings wherein like reference characters identify corresponding or similar elements throughout the several views, FIG. 1 depicts an oblique view of a sexual stimulation apparatus 101 in accordance with a preferred embodiment of the present application. It will be appreciated that apparatus 101 overcomes one or more of the above-listed problems commonly associated with conventional sexual stimulation devices.

In the contemplated embodiment, apparatus 101 includes a stand 601 having a first portion 103 and a second portion 105 connected by a pivoting hinge 107. Hinge 107 allows for the angle between portion 103 and 105 to change, as well as provides a means for portion 103 and 105 to collapse for storage/transportation. Apparatus 101 further includes a base 109 pivotally attached to portion 105. In one embodiment, a first dildo 111 is removably secured to first portion 103 by an attachment device 113 and a second dildo 115 is removably secured to second portion 105 by an attachment device 117. It should be appreciated that more than two dildos can be attached to first and second portions 103, 105 at various locations.

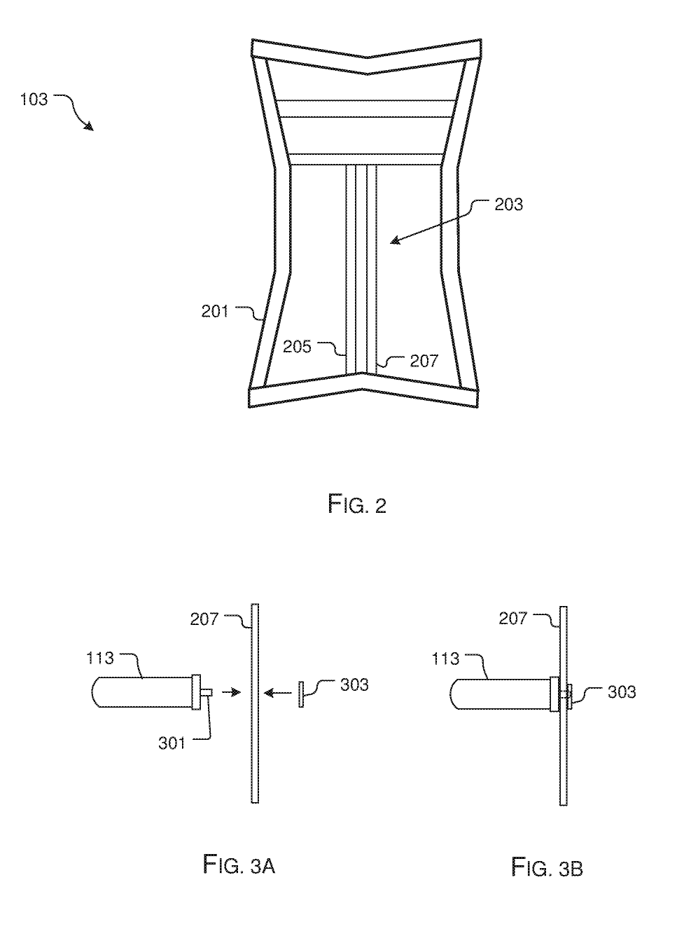

In FIG. 2, a front view of a first embodiment of portion 103 is shown. It should be appreciated that portion 105 is similar in form and function to portion 103. Portion 103 includes a frame 201 configured to provide structure, and a track 203 positioned within the interior of frame 201 and configured to receive dildo 113. Track 203 can include a first rail 205 and a second rail 207, thereby providing multiple positions to attach dildo 113.

In FIGS. 3A and 3B side views demonstrating the attachment of dildo 113 to track 203 are shown. One means of attaching dildo 113 includes a bolt 301 shaped appropriately to be inserted between rails 205, 207 and a nut 303 to secure bolt 301 in place.

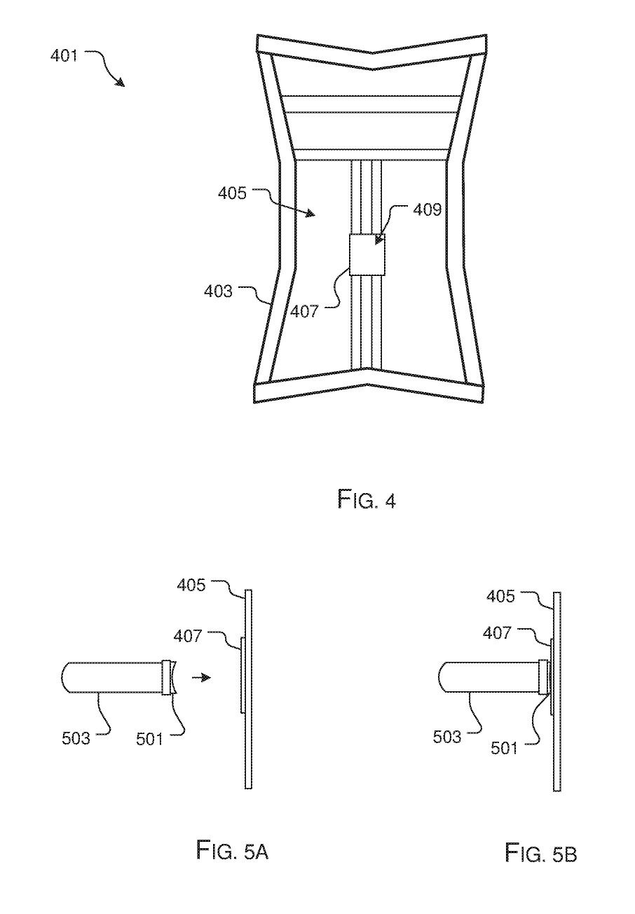

In FIG. 4, a front view of an alternative embodiment of a first portion 401 is shown. Portion 401 includes a frame 403 and a track 405, similar in form and function to portion 103. In addition, a plate 407 is secured to track 405, wherein the surface 409 of plate 407 provides a location for a suction cup 501 to attach to. As shown in FIGS. 5A and 5B, suction cup 501 is configured to secure a dildo 503 to plate 407.

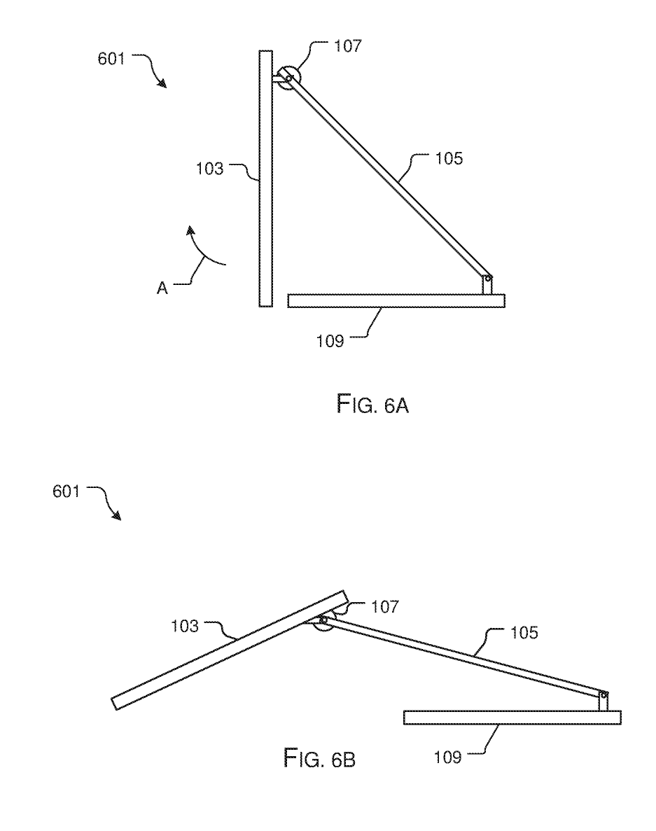

In FIGS. 6A and 6B, side views of stand 601 are shown. As previously discussed, hinge 107 is configured to allow for portion 103 to pivot upward (as shown with arrow A) or downward, thereby allowing for the angles of dildos 113, 115 to change based on the user's preference.

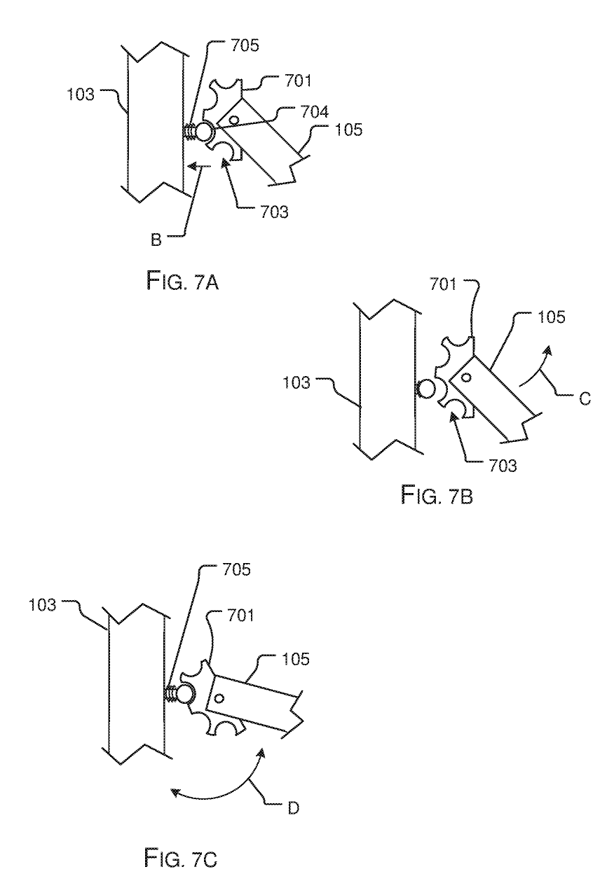

In FIGS. 7A-7C, close up side views depict one type of hinge 701 having a ratcheting function configured to provide pivoting as shown in FIGS. 6A and 6B. Hinge 701 includes a plurality of notches 703 configured to engage with a rod 704 extending from first portion 103. Rod 704 is attached to a spring 705, thereby providing a means for rod 704 to compress away from hinge 701, as shown with arrow B. Portion 105 can then rotate up or down, as shown with arrow C, thereby altering the angle D between portions 103 and 105.

It should be appreciated that one of the unique features believed characteristic of the present application is the connection of two portions by a ratcheting hinge, wherein each portion is configured to receive one or more dildos. It should be appreciated that this feature provides for the apparatus to be manipulate as desired by the user to position the one or more dildos as desired angles. In addition, this feature allows for the apparatus to fold into a compact position, thereby being convenient for storage.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A sexual stimulation apparatus, comprising:
a stand, having:
a first portion;
a second portion pivotally attached to the first portion by a hinge; and
a base pivotally attached to the second portion;
wherein the stand unfolds into an A-frame with the first potion being a first leg and the second portion being a second leg;
a first dildo having a first attachment device configured to removably secure the first dildo to the first portion; and
wherein the stand folds substantially flat for storage.

2. The apparatus of claim 1, wherein the hinge is a ratcheting hinge configured to allow the first portion to be secured at a plurality of angles relative to the second portion.

3. The apparatus of claim 1, wherein the first portion and second portion each comprise:
a frame; and
a track running from a bottom of the frame to a top of the frame;
wherein the first attachment device is configured to removably secure to the track of the first portion; and
wherein the track provides a plurality of locations on which to attach the attachment device.

4. The apparatus of claim 1, wherein the attachment device comprises:
a screw; and
a nut.

5. The apparatus of claim 1, further comprising:
a plate attached to the first portion, the plate having an outward facing face.

6. The apparatus of claim 5, wherein the first attachment device is a suction cup configured to attach to the plate.

7. The apparatus of claim 1, wherein the first portion further comprises:
a frame; and
a handle secured to a top of the frame.

8. The apparatus of claim 1, further comprising:
a second dildo having a second attachment device configured to removably secure to the second portion.
